(19) United States
(12) Patent Application Publication
(10) Pub. No.: US 2015/0342825 A1
(43) Pub. Date: Dec. 3, 2015

(54) LIP AUGMENTATION DEVICE & METHOD OF USE

(71) Applicants: Lilita Shabazian, Hollywood, FL (US); Jonathan Osborne, Ft. Lauderdale, FL (US)

(72) Inventors: Lilita Shabazian, Hollywood, FL (US); Jonathan Osborne, Ft. Lauderdale, FL (US)

(21) Appl. No.: 14/815,905

(22) Filed: Jul. 31, 2015

Related U.S. Application Data
(63) Continuation-in-part of application No. 13/329,388, filed on Dec. 19, 2011.

(51) Int. Cl. A61H 23/00

(52) U.S. Cl. CPC A61H 23/00; A61H 2205/022; A61H 2201/169; A61H 2201/1645

(57) ABSTRACT

The invention is directed to a lip augmentation device. The device includes a housing and a vibrating member is disposed within the housing. The vibrating member provides a plurality of vibrations, which is uniformly distributed throughout a the lip plumping member. The lip plumping member is operably attached to the housing and is disposed in a vibrating relation with the vibrating member. The lip plumping member is disposed to receive at least a portion of the user's lips. While engaged with the lips, the lip plumping member uniformly augments the user's lips by supplying the plurality of vibrations to the user's lips. The lip plumping member may further include a plurality of groove and ridge members. The members are substantially adjacent and parallel in relation to each other. The invention is also directed to a method of uniformly augmenting at least a portion of the user's lips using the lip augmentation device.

### CLAIM OF PRIORITY

The present continuation-in-part application is based on and a claim for priority under 35 U.S.C. Section 120 to a non-provisional patent application that is currently pending in the U.S. Patent and Trademark Office, namely, that having Ser. No. 13/329,388 and a filing date of Dec. 19, 2011, and which is incorporated herein with reference.

### BACKGROUND OF THE INVENTION

1. Field of the Invention

This invention generally relates to a device and method of augmenting a user's lips. More specifically, this invention describes a lip augmentation device and its method of use, where the said device is disposed onto at least a portion of the user's lips and utilizes vibration to facilitate uniform augmentation of the lips.

2. Description of Related Art

One of the most perceptible trends in the cosmetic industry is lip augmentation. Voluminous lips with an accentuated border are often identified as the epitome of beauty in the aesthetic world. Beauty experts suggest that because lips occupy dual dimensions within the topographic subdivisions of a human face, they can constitute a major focal point of an individual's overall beauty.

Fuller lips can also yield an enhanced version of beauty and youth. Not surprisingly, therefore, having plumped lips is highly sought after. Many people spend thousands of dollars on injections, fillers and other cosmetic surgeries. Mainstream media constantly floods the cosmetic industry with novel ways for people to inject, plump, or define their lips. In fact, celebrities with plump lips have been thrust into the mainstream limelight as movie stars, singers, and models for decades. Unsurprisingly, therefore, lip augmentation devices and procedures have been on an unprecedented rise in the United States and other nations around the world in recent years.

Having thinner lips is not an issue solely faced by those who are genetically disposed. People with naturally plumper lips can also face issues of thinning lips. Medical studies show that several biological and environmental factors can affect the size of human lips. For instance, most dermatologists agree that the risk from sun damage due to harmful ultraviolet light, as well as factors like smoking, drinking, and the natural process of aging, can trigger human bodies to produce less collagen, resulting in thinner lips. This is because lips get their shape and size in part from collagen. As the body ages, it produces less of this critical protein, resulting in the lips' losing their volume.

Cosmetic experts agree that acquiring fuller lips is a highly arduous task. For decades, plastic surgeons have been hopelessly attempting to help patients acquire the coveted plumped lips appearance. Most notably, anatomical zones of human lips are injected with harmful fillers in order to attain plumped lips. However, the results from these trials have been less than satisfactory. The lips often appear artificial, asymmetrical and aesthetically terrifying.

To remedy the problem of thin or thinning lips, the cosmetic industry is desperately searching for viable solutions. The initial search has prompted some lip plumping devices sans cosmetic surgery. One such device in the market is a self-suction cup device. The self-suction cup device is structured to target only the larger anatomical portions of the user's lips. Specifically, the device comprises a housing structured and disposed to accommodate the larger portions of the user's lips. As such, the housing is attached to a brim member having an outer surface. The outer surface is positioned to contact and temporarily adhere to a peripheral area surrounding the user's lips, by forming a vacuum when the user stimulates a suctioning motion. The suctioning motion causes the user's lips to forcibly contour within the limited dimensions of the housing, thereby generating the necessary vacuum on the user's lips. The vacuum causes vasoconstriction and fluid retention in the lips, resulting in temporary swelling of the lips, and thus revealing a plump lip appearance.

However, the device is flawed with many deficiencies and side effects. For instance, the device can cause significant pain, swelling, inflammation, and bruising of the user's lips from the suctioning technique required by the device. Scarring and permanent disfigurement of the lips are also potential risks associated with repeated attempts from the user. Moreover, the device is structured to plump only the larger anatomical lobes of the user's lips, ignoring other parts. The limited structure of the device also disregards the significance of uniformity required in lip plumping. Without uniformity, the lips can appear asymmetrical and, underscoring an artificial look, rather than a natural, smoother and fuller lip appearance. In addition, the results from using the device are only temporary. The lips sustain their plumpness merely for a few minutes, so long as the large anatomical lobes of the lips remain irritated, requiring the user to effectuate continuous therapy over a short period of time. Therefore, the device is not adequate for a safe, productive, long-term use that the cosmetic industry is seeking.

Another similar device currently on the market to plump human lips is a lip-enhancing device dimensioned in a fruit like configuration. The lip-enhancing device is structured to raise the arches of the double curve of the user's upper lip and simultaneously provide a double-lobed appearance of the user's lower lip. Specifically, the lip-enhancing device has a generally circular housing with an aperture. A blocking member compartmentalizes the aperture of the generally circular housing into an upper compartment and a lower compartment, wherein the user's upper lip can be positioned within the upper compartment of the aperture while the user's lower lip can be positioned within the lower compartment of the aperture. The blocking member allows the user's upper lip and the user's lower lip to be enlarged separately within each of the respective portions. Furthermore, a secondary partition member is positioned within the lower compartment of the aperture. The secondary partition member further proportions the lower compartment of the aperture into two sections. Each of the two sections of the lower portion of the aperture is structured to accommodate each of the two respective anatomical lobes of the lower lips of the user, sufficient to eventually yield the double-lobed appearance of the lower lip.

However, the aforementioned lip-enhancing device is riddled with notable flaws and lingering side effects. Specifically, when used, the device yields overly disproportionate swollen lips. Additionally, the device is known to cause haunting side effects for the user. These side effects include, but are not limited to severe bruising of the lips, cold sores, bleeding blisters, and abrasions. Therefore, as it is evident, the device is neither suitable nor safe as an effective means to plump the lips of the user as desired by the cosmetic industry.

There are also other non-surgical methods to enhance the lips of the user. One of these methods includes lip injections. Lip injections with dermal fillers are effective in temporarily augmenting the lips, but they include many deficiencies and side effects for the user. Specifically, the injections and multiple doctor visits can be expensive, time consuming, and painful. They can often leave unsightly bruising on the user's lips and surrounding mouth area for a long period of time. Common side effects can often range from redness, swelling or itching at the injection sites. Extrusion is also possible, when the dermal filler breaks through the outermost surface of the skin. Lip injections also tend to have higher risk for infection and permanent deformation of the user's lips. Therefore, lip injections are, again, not the viable solution that the cosmetic industry desires.

Surgical methods are also considered as an option to permanently enhance the user's lips. However, lip implants can also yield painful results. They require a plethora of pain management medications long after the implants have been surgically inserted. Common side effects include clotting, scarring of the lips, herpes lesions, and possible facial nerve disorders. Lip implants can also cause deformation and infection of the surrounding areas, requiring additional surgeries and expenses, often not covered under the user's medical insurance. Lip implants, therefore, are neither comprehensively safe nor inexpensive. They are not the solution that the cosmetic industry is seeking.

Another method to augment lips consists of cosmetic formulations. These too, however, are expensive and often do not yield the desired result as intended. In fact, in most cases the results are almost invisible. The lip plumping effect is not visually evident and appears to yield no changes. Cosmetic formulations also contain painful vasodilators like red pepper, which can induce a severe burning or stinging sensation for a prolonged time. Therefore, cosmetic formulations lack the optimal results, can be painful, and are expensive. Again, they are not the option that the cosmetic industry is seeking.

The market, therefore, is in need of a safe, uniform, inexpensive, and quick lip augmentation device. A lip augmentation device that can provide the user with an all-natural, aesthetically uniform, extremely effective, longer lasting lip plumping is needed. In addition, a lip augmentation device that has minimal side effects, and which is portable, reliable, easy to manufacture and inexpensive to purchase is desired.

### SUMMARY OF THE INVENTION

The present invention is intended to provide a solution to these and other needs, which remain in the relevant field of art. As such, and for purposes of clarity in describing the structural and operative features in at least one preferred embodiment, the present invention is directed to a lip augmentation device. The lip augmentation device has a housing. The housing can accommodate some of the structural elements of the lip augmentation device within its internal dimensions. The housing may comprise of an inner body member and an outer body member. The inner body member is disposed within the outer body member. The inner body member can also be attached to the outer body member.

The housing can also be structured in various configurations. The configurations may include, but are not limited to circular, rectangular, triangular, square, and other polygons. The configurations of the housing are structured for gripping and/or holding means. The gripping and holding characteristic of the housing allows the user to hold and grip the lip augmentation device, when the device is operationally used.

The lip augmentation device has a vibrating member. The vibrating member is disposed within the housing. The vibrating member can be a vibrating motor or similar structures for supplying a plurality of vibrations within a range of frequency and amplitude. The vibrating member is attached to an energy source. The energy source can be a battery, an electrical outlet or other forms of energy, providing the necessary power for the vibrating member to supply the vibrations. The vibrating member may include other structural features to provide the vibrations, including its circuitry.

The plurality of vibrations provided by the vibrating member may contribute to a uniform augmentation of a user's lips by increasing blood flow to the user's lips. The plurality of vibrations is comprised of a range of frequency and amplitude. In at least one of the preferred embodiments, the frequency of the plurality of vibrations can be in the range of about 40 Hertz to about 100 Hertz. The frequency range, however, is not limited. The vibrating member can be configured to provide vibrations in other ranges of frequencies. The frequency ranges may depend on several factors such as time of use, integrity of the user's lips, desired look of the user, etc.

The lip augmentation device includes a lip plumping member. In at least one preferred embodiment, the lip plumping member is attached to the vibrating member. The lip plumping member is attached to the vibrating member such that the lip plumping member can be superimposed on the vibrating member. As such, at least a portion of the lip plumping member can be attached to at least a portion of the vibrating member while the vibrating member is disposed within the housing. In this preferred embodiment, the vibrating member can be suspended freely within the housing without any structural attachments to the internal dimensions of the housing. In addition, the lip plumping member can be attached to the housing member via an overmold member. The suspension of the vibrating member within the housing allows for the vibrations provided by the vibrating member to be concentrated primarily on the lip plumping member.

In other preferred embodiments, the vibrating member may not be attached to the lip plumping member. The vibrating member is disposed in a confronting relation with the lip plumping member. The vibrating member is positioned within a proximal distance from the lip plumping member, sufficient for the vibrating member to provide the plurality of vibrations. The vibrations provided are thereby uniformly dispersed onto the lip plumping member.

Furthermore, the lip plumping member is disposed in a vibrating relation with the vibrating member. The vibrating member may provide a plurality of vibrations to the lip plumping member. The vibrations are within the desired range of frequency and amplitude and are uniformly dispersed throughout the lip plumping member. As such, the lip plumping member is structured for uniform dispersing of vibrations on the user's lips. The uniform dispersion of the vibrations onto the lip plumping member contributes towards the uniform augmentation of the user's lips by increasing blood flow to the user's lips when the user's lips are engaged with the lip plumping member.

The lip plumping member is also disposed to provide the plurality of vibrations to at least the portion of the user's lips in a perpendicular orientation relative to the lips. Specifically, the frequency and amplitude of vibrations are provided by the lip plumping member. In some of the preferred embodiments, when contacted and/or engaged with the surface of the user's lips, the lip plumping member is aligned and positioned to allow the vibrations provided by the lip plumping member to perpendicularly vibrate the desired portions of the user's lips. This increases the intensity of vibrations and allows for uniform dispersion of vibrations onto the lip plumping member. In addition, the perpendicular orientation of the lip plumping member allows the body to induce its own natural production and flow of hyaluronic acid. This is because hyaluronic acid is highly beneficial. It is used as dermal filler in cosmetic lip augmentation procedures. Having a perpendicular orientation, therefore, ensures a natural, long-term, anti-aging, lip plumping effect in addition to the lip augmentation resulting from the lip augmentation device of the present invention.

In other preferred embodiments, the lip plumping member is operably attached to the housing. In particular, the lip plumping member can be temporarily attached to the housing, when the device is disposed to augment the user's lips.

Alternatively, the lip plumping member can also be temporarily detached from the housing, when the device is not disposed for use and/or requires external or internal repair. In addition, the lip plumping member is structured and disposed to receive at least a portion of the user's lips. In other words, the lip plumping member can accommodate any shape, size and/or type of lips.

The lip plumping member can be substantially concave in relation to the user's lips. In one of the preferred embodiments, the substantially concave configuration of the lip plumping member may resemble an outline or surface that curves inward like the interior of a circle or sphere in relation to the user's lips. The substantially concave configuration is structured to allow the user to effortlessly engage the lips with the lip plumping member during the lip augmentation process. As a result, at least a portion of the user's lips can contour within the dimensions of the lip plumping member. The concave configuration of the lip plumping member further ensures that the user's lips are uniformly augmented throughout the lip augmentation procedure. In addition, the substantially concave configuration of the lip plumping member is not limited, permitting the user to uniformly augment any portion of the user's lips. The substantially concave configuration of the lip plumping member can also help prevent any structural damages to the user's lips, ensuring that the results are safe, consistent, and uniform for the user.

The lip plumping member can be substantially convex in relation to the user's lips. In another one of the preferred embodiments, the substantially convex configuration of the lip plumping member may resemble an outline or surface curved like the exterior of a circle or sphere in relation to the user's lips. This configuration in relation to the user's lips allows the user to easily engage any portion of user's lips with the lip plumping member during lip augmentation process. As a result, at least a portion of the user's lips can contour with the dimensions of the lip plumping member for optimal results. The convex configuration of the lip plumping member further ensures that the user's lips are uniformly augmented during the lip augmentation procedure. This means that the convex configuration of the lip plumping member is not limited, uniformly augmenting all the desired portions of the lips. The substantially convex configuration of the lip plumping member can also help prevent any structural damages to the user's lips, ensuring a safe, consistent, and uniform lip augmentation experience for the user.

In other preferred embodiments, the lip plumping member further includes a plurality of groove and ridge members. Each of the groove and ridge members are disposed in a substantially adjacent and parallel relation to each other. The plurality of groove and ridge members are also disposed in a vibrating relation to the vibrating member. As such, each of the groove and ridge members receive a plurality of vibrations provided by the vibrating member. Specifically, the vibrating member supplies a frequency and amplitude of vibrations to each of the groove and ridge members. As such, the frequency of vibrations provided by the vibrating member can be in the range of about 40 Hertz to about 100 Hertz. However, the frequency of vibrations provided by the vibrating member can be lower or higher depending on several aforementioned factors. In addition, the frequency and amplitude of vibrations provided by the vibrating member is uniformly distributed throughout each of the plurality of groove and ridge members. The resulting smaller surface area that comes in contact with the lips results in a higher intensity of vibration in the areas where the grooves touch the lip surface of the user. Further, the structural features of each of the members combined with the uniformity of the vibrations ensure that the user's lips are uniformly augmented.

In other preferred embodiments, the lip augmentation device includes other structural elements. One such structural feature includes a bushing member. The bushing member is positioned within the housing. It is disposed to allow the plurality of vibrations within a preferred range of frequency and amplitude provided by the vibrating member to be dampened. Dampening the frequency and amplitude of vibrations reduces the unwarranted movement of the vibrations to other parts of the lip augmentation device. By dissipating the plurality of vibrations from other parts, the frequency of vibrations can be focused onto the lip plumping member with minimal vibration effect on the housing and/or other areas of the lip augmentation device, where vibrations are not particularly necessary nor desired.

Other structural aspects of the lip augmentation device include a button switch member. The button switch member can be disposed anywhere on the housing. It is configured to interrupt the flow of energy to the circuit and to the vibrating member. The button switch member is configured to remain in one state unless actuated—either completely on (“closed”) or completely off (“open”).

Now that the structural features of the lip augmentation device have been disclosed, the present invention also includes a method of uniformly augmenting at least a portion of a user's lips with a lip augmentation device. The lip augmentation device includes a housing, a lip plumping member, and a vibrating member. Accordingly, the method of uniformly augmenting at least a portion of the user's lips with the lip augmentation device includes aligning the lip plumping member with the portion of the user's lips. In this method, the user ensures that the lip plumping member is aligned with at least a portion of the user's lips so as to allow the lip plumping member to accommodate the portion of the lips. While aligning the lip plumping member to accommodate the lips, the user ensures that the method of uniformly augmenting at least the portion of the user's lips with a lip augmentation device further includes positioning the lip plumping member in relation to the portion of the user's lips such that the plurality of vibrations are delivered in a perpendicular orientation onto the portion of the user's lips. In this method, the user positions the lip augmentation device so as to allow the plurality of vibrations from the lip plumping member to vibrate the user's lips in a perpendicular or an “up and down” motion.

Further, the method of uniformly augmenting at least the portion of the user's lips with a lip augmentation device includes engaging the lip plumping member with the portion of the user's lips such that the portion of the user's lips contour with the lip plumping member. In this method, the lip plumping member is structured to sufficiently accommodate the user's lips desired for augmentation. Once contact is established between the user's lips and the lip plumping member, the user's lips contour with the lip plumping member by allowing the surface of the user's lips to sufficiently engage with the lip plumping member.

Looking further, the method of uniformly augmenting at least the portion of the user's lips with a lip augmentation device includes providing a plurality of vibrations through the lip plumping member uniformly onto the portion of the user's lips for a predetermined amount of time. In this method, the uniformly dispersed vibrations from the vibrating member on the lip plumping member allows the user to uniformly augment at least a portion of the user's lips. Specifically, in at least one of the preferred embodiments, the plurality of vibrations through the lip plumping member have a frequency in the range of about 40 Hertz to about 100 Hertz. Accordingly, the user may augment the lips for a predetermined amount of time and/or until desired results from augmentation are generated.

The method of uniformly augmenting at least the portion of the user's lips with a lip augmentation device further includes applying a predetermined amount of pressure onto the lip plumping member, while the lip plumping member is engaged with the portion of the user's lips for a predetermined amount of time. In this method, the user applies pressure on the lip plumping member for a predetermined amount of time so as to allow the plurality of vibrations from the lip plumping member to effectively vibrate the portion of the user's lips within the desired range of frequency and amplitude.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be made to the following detailed description taken in connection with the accompanying drawings in which:

FIG. 1 is a perspective view of the present invention illustrating a lip augmentation device in accordance to one of the preferred embodiments.

FIG. 2 is an exploded view of the present invention illustrating the lip augmentation device in accordance to one of the preferred embodiments.

FIG. 3 is a sectional view of the present invention illustrating the lip augmentation device in accordance to one of the preferred embodiments.

FIG. 4 is a perspective view of the present invention illustrating a lip plumping member in accordance to one of the preferred embodiments.

FIG. 5 is a perspective view of the present invention illustrating the lip plumping member in accordance to one of the preferred embodiments.

FIG. 6a is a top elevation view of the present invention illustrating the lip augmentation device aligned before engagement with a user's lips in accordance to one of the preferred embodiments.

FIG. 6b is a side elevation view of the present invention illustrating the lip augmentation device aligned before engagement with the user's lips in accordance to one of the preferred embodiments.

FIG. 7 is a flow chart of a method of the present invention for uniformly augmenting at least a portion of a user's lips with a lip augmentation device.

Like reference numerals refer to like parts throughout the several views of the drawings.

### DETAILED DESCRIPTION OF THE PREFERRED EMBODIMENT

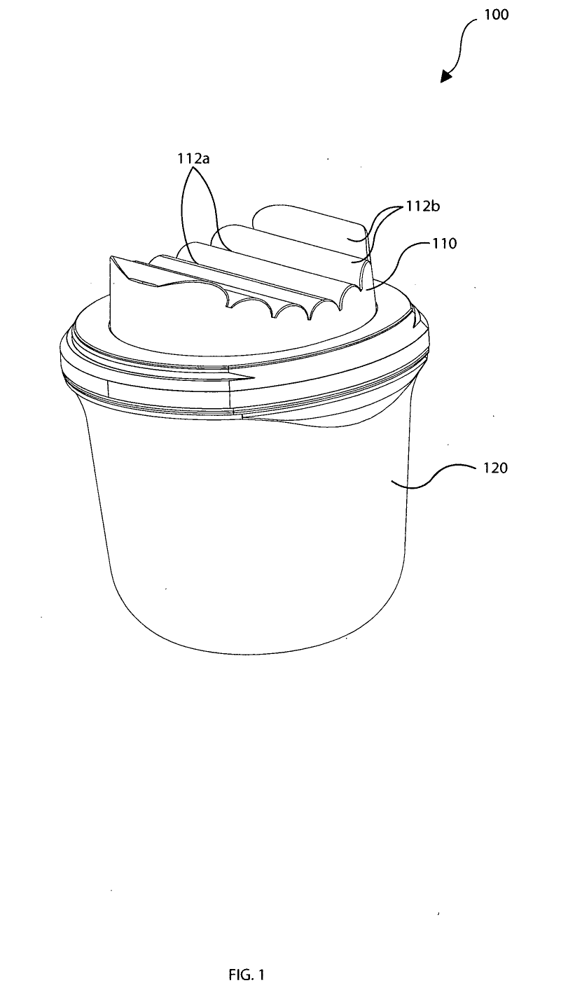

As shown in the accompanying drawings, the present invention includes a lip augmentation device 100. As illustrated in FIG. 1, the lip augmentation device 100 has a housing 120. The housing 120 of the device 100 is dimensioned to accommodate at least some of the structural aspects of the present invention within its internal dimensions. The housing 120 may comprise of an inner body member 120a and an outer body member 120b. The inner body member 120a is disposed within the internal dimensions of the outer body member 120b. The inner body member 120a is also attached to the outer body member 120b.

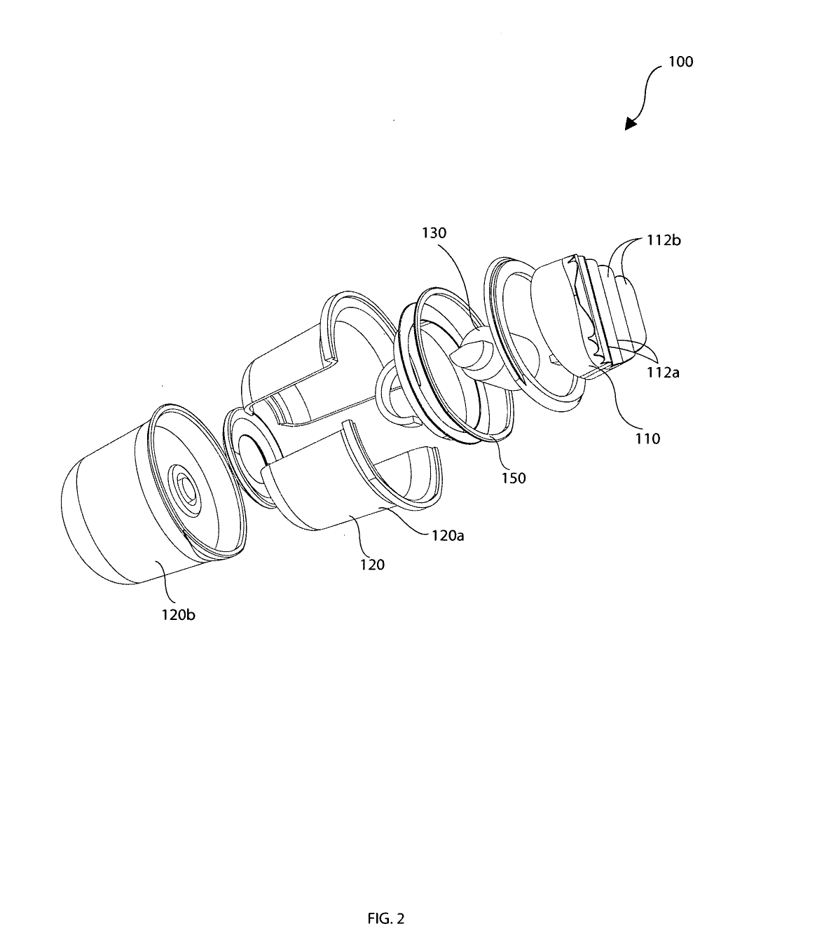

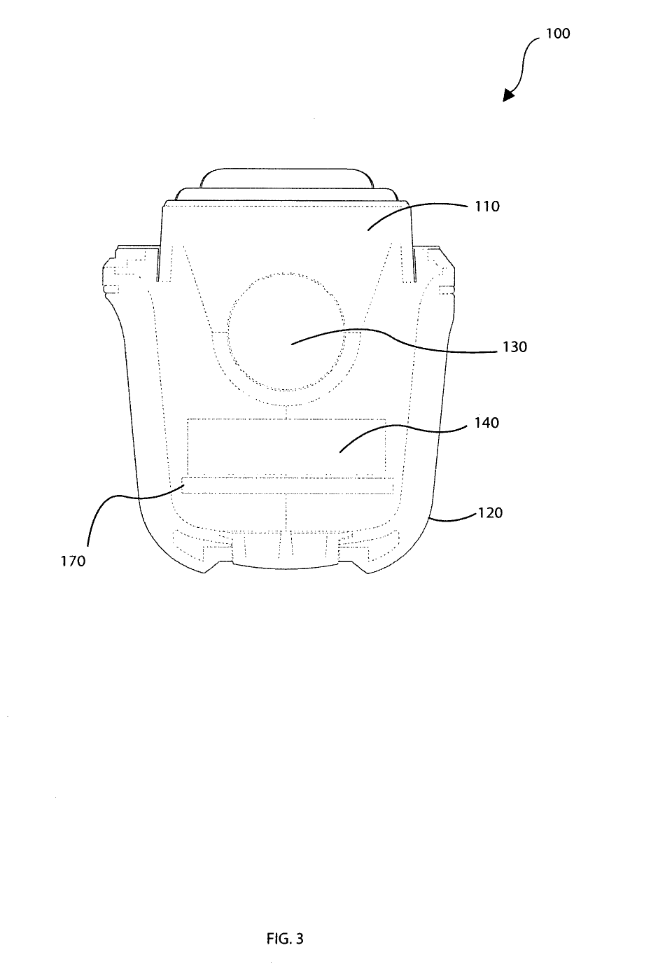

Referring now to FIG. 2 and FIG. 3, in at least one of the preferred embodiments, the lip augmentation device 100 has a vibrating member 130. The vibrating member 130 is disposed within the housing 120. The vibrating member 130 is attached to an energy source 140. The energy source 140 can be a battery, an electrical outlet or other forms of energy, sufficient for the vibrating member 130 to operate with a necessary power. The vibrating member 130 may include other structural features to provide the vibrations. These may include, but are not limited to its circuitry 170.

Referring again to FIG. 2 and FIG. 3, the vibrating member 130 is structured and disposed to provide a plurality of vibrations (not shown). Specifically, the vibrating member 130 is structured and disposed to vibrate within a range of frequency and amplitude. The frequency and amplitude of vibrations from the vibrating member 130 may contribute towards uniform augmentation of at least a portion of a user's lips within a predetermined amount of time. The frequency of vibrations provided by the vibrating member 130 is preferably within a range of about 40 Hertz to about 100 Hertz. However, the range is not limited. The vibrating member 130 can be configured to provide a wide range of frequencies, including a lower or higher range of frequency and amplitude of vibrations. The vibrating member 130 also includes other structural features. One of these may include its related circuitry 170. The circuitry 170 allows the vibrating member 130 to function properly and provide the plurality of vibrations within the range of frequency and amplitude.

Referring again to FIG. 1 and FIG. 2, in at least another one of the preferred embodiments, the lip augmentation device 100 includes a lip plumping member 110. The lip plumping member 110 is attached to the vibrating member 130. Referring now to FIG. 3, the lip plumping member 110 can be superimposed on the vibrating member 130. At least a portion of the lip plumping member 110 is attached to at least a portion of the vibrating member 130, while the vibrating member 130 is disposed within the housing 120.

Alternatively, in other preferred embodiments, the vibrating member 130 may be attached to the lip plumping member, wherein the vibrating member 130 may be positioned freely so as to suspend without any attachments to the inner dimensions of the housing 120. As such, the vibrating member is suspended within the inner body 120a of the housing 120 while maintaining its connection to the lip plumping member 110 and to its energy source 140 and circuitry 170. As such, the lip plumping member 110 may be attached to the housing 120 via an overmold member 180. The suspended disposition of the vibrating member 130 within the housing 120 allows the plurality of vibrations to primarily focus on the lip plumping member 110. In other preferred embodiments, the vibrating member 130 may also be disposed in a confronting relation with the lip plumping member 110 (not shown). The vibrating member 130 is positioned within proximity of the lip plumping member 110, which is sufficient for the vibrating member 130 to provide and the lip plumping member 110 with a plurality of vibrations uniformly. The vibrating member 130 is also attached to the energy source 140 and its circuitry 170 as illustrated in FIG. 3.

Referring now to FIG. 2 and FIG. 3, in other preferred embodiments, the lip plumping member 110 is disposed in a vibrating relation with the vibrating member 130. The vibrating member 130 provides a plurality of vibrations to the lip plumping member 110 (not shown). The plurality of vibrations provided can be within a predetermined range of frequency and amplitude. The plurality of vibrations can be uniformly dispersed throughout the lip plumping member 110. The dispersion of the vibrations on the lip plumping member 110 combined with the structure of the lip plumping member 110 can uniformly augment the user's lips when the lip plumping member 110 is disposed and engaged with the user's lips.

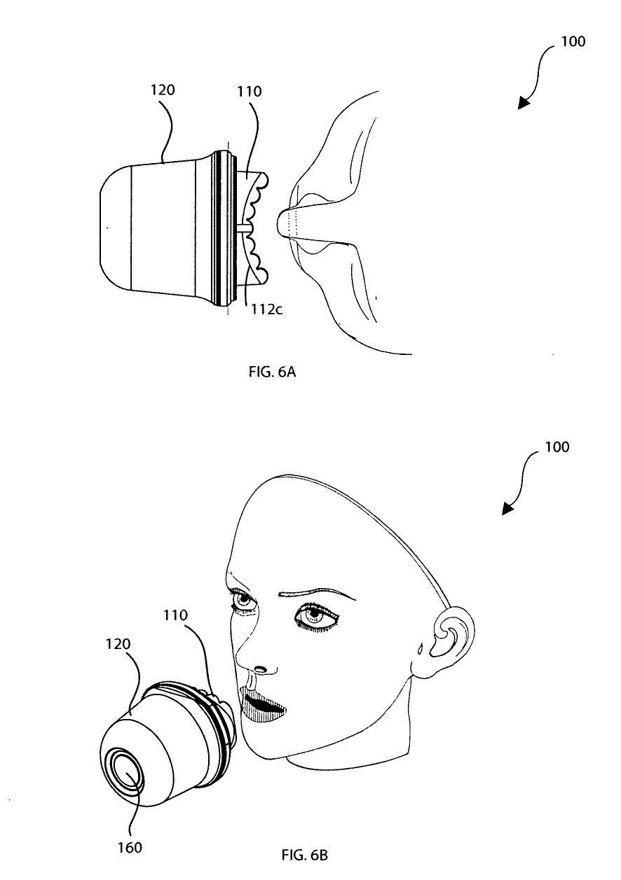

Referring to FIGS. 6a and 6b, in at least one of the preferred embodiments, the lip plumping member 110 is disposed to provide perpendicular vibrations onto the user's lips. For instance, FIG. 6a and FIG. 6b illustrate that when the device 100 is positioned in relation to the lips, the lip plumping member 110 is positioned so as to provide perpendicularly oriented vibrations onto at least the portion of the user's lips. Accordingly, the lip plumping member 110 provides the vibrations within a frequency and amplitude suitable for optimal lip augmentation. As such, the user's lips are vibrated in a perpendicular (up and down) motion in relation to the user's face, thereby allowing the body to induce its own natural production and flow of hyaluronic acid.

As shown in FIG. 1, in one of the preferred embodiments, the lip plumping member 110 is operably attached to the housing 120. The lip plumping member 110 can be temporarily attached to the housing 120, while the lip augmentation device 100 is disposed to augment the user's lips. Alternatively, the lip plumping member 110 can be temporarily detached from the housing 120, when the lip augmentation device 100 is not disposed for use or requires repair (not shown).

Furthermore, FIGS. 6a and 6b illustrate the lip plumping member 110 being disposed to receive at least a portion of the user's lips. The lip plumping member 110 is structured to accommodate a variety of lips notwithstanding their dimensions and/or texture, when the user desires to augment the portion of the lips.

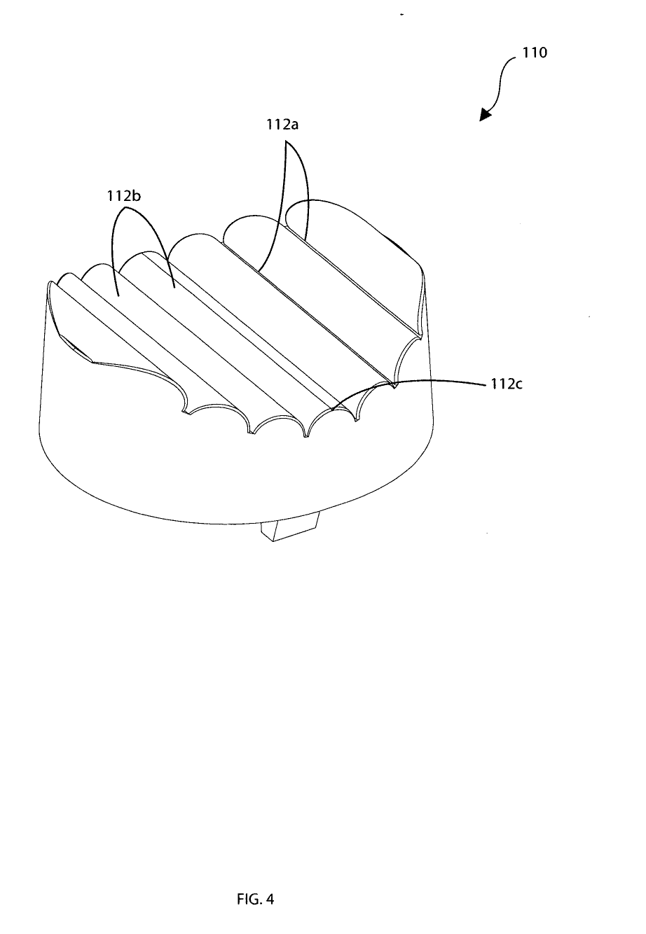

As best shown, FIG. 4 and FIG. 6a illustrate the lip plumping member 110 structured to be substantially concave 112c in relation to the user's lips. The substantially concave configuration 112c of the lip plumping member 110 may have an outline or surface that curves inward like the interior of a circle or sphere in relation to the user's lips. In at least one of the preferred embodiments, the substantially concave configuration 112c allows the user to engage the lips with the lip plumping member 110 during lip augmentation. As a result, and due to the orientation of the lips in their natural form, the portion of the user's lips can contour seamlessly with the lip plumping member 110. In addition, the concave configuration 112c of the lip plumping member 110 ensures that the user's lips are uniformly augmented throughout the lip augmentation process. The substantially concave configuration 112c of the lip plumping member 110 also allows the user to uniformly augment any portion of the user's lips. The substantially concave configuration 112c of the lip plumping member 110 may also help prevent any structural damages to the user's lips, ensuring that the results are safe, consistent, and uniform for the user.

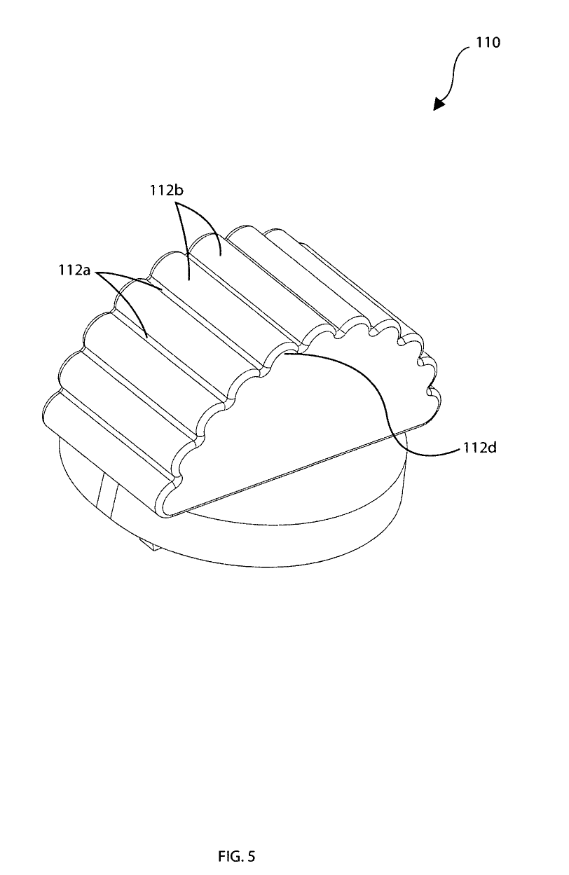

As best shown in FIG. 5, in yet another one of the preferred embodiments, the lip plumping member 110 may be structured to be substantially convex 112d in relation to the user's lips. The substantially convex configuration 112d of the lip plumping member 110 has an outline or surface curved like the exterior of a circle or sphere in relation to the user's lips. This configuration 112d in relation to the user's lips, allows the user to easily engage any portion of user's lips with the lip plumping member 110 during lip augmentation. As a result, the portion of the user's lips seamlessly contour with the dimensions of the lip plumping member 110 for optimal lip augmentation on the desired areas of the lips. The convex configuration 112d of the lip plumping member 110 further ensures that the user's lips are uniformly augmented during the lip augmentation procedure. It enables the user to uniformly augment all the desired portions of the lips. Further, the substantially convex configuration 112d of the lip plumping member may help prevent any structural damage to the user's lips, ensuring a safe, consistent, and uniform lip augmentation experience for the user.

Referring now to FIGS. 1, 2, 4, and 5, in at least one of the other preferred embodiments, the lip plumping member 110 includes a plurality of groove 112a and ridge 112b members. Specifically as shown in FIG. 4 and FIG. 5, all of the groove 112a and ridge 112b members are disposed in a substantially adjacent and parallel relation to each other. The groove 112a and ridge 112b members are also disposed in a vibrating relation to the vibrating member 130, such that all of the groove 112a and ridge 112b members are disposed to receive the plurality of vibrations provided by the vibrating member 130. The frequency of vibrations provided by the vibrating member 130 can be in the range of about 40 Hertz to about 100 Hertz. In addition, the frequency of vibrations provided by the vibrating member 130 can be uniformly distributed throughout all the groove 112a and ridge 112b members. The resulting smaller surface area of the members 112a, 112b that comes in contact with the user's lips results in a higher intensity of vibration in the areas, where each of the groove members 112a comes in contact with the lip surface of the user. As such, the structural features of each of the members 112a, 112b and the uniform dispersion of the plurality of vibrations provided by the vibrating member 130 ensure that the user's lips will be uniformly augmented.

Referring now to FIG. 2, in other preferred embodiments, the lip augmentation device 100 may comprise other structural elements. One such element includes a bushing member 150. The bushing member 150 is positioned within the housing 120. It is disposed to allow the plurality of vibrations (frequency and/or amplitude of vibrations) provided by the vibrating member 130 to be dampened. Dampening the frequency and/or amplitude of vibrations reduces the unwarranted movement of the vibrations to other parts of the lip augmentation device 100. Thus, by dissipating the vibrations from other parts, the plurality of vibrations is concentrated directly on the desired areas such as lip plumping member 110, including the plurality of groove 112a and ridge 112b members, without any vibration effect on the housing 120 and/or other parts of the lip augmentation device 100, where the plurality of vibrations is not particularly necessary nor desired.

Other structural features of the lip augmentation device 100 include a button switch member 160. As illustrated specifically in FIG. 6b, the button switch member 160 is disposed on the housing 120. In particular, the button switch member 160 is configured to interrupt the flow of energy in the circuit, including the energy source 140 and thereby the vibrating member 130. The button switch member 160 is configured to remain in one state unless actuated—either completely on (“closed circuit 170”) or completely off (“open circuit 170”).

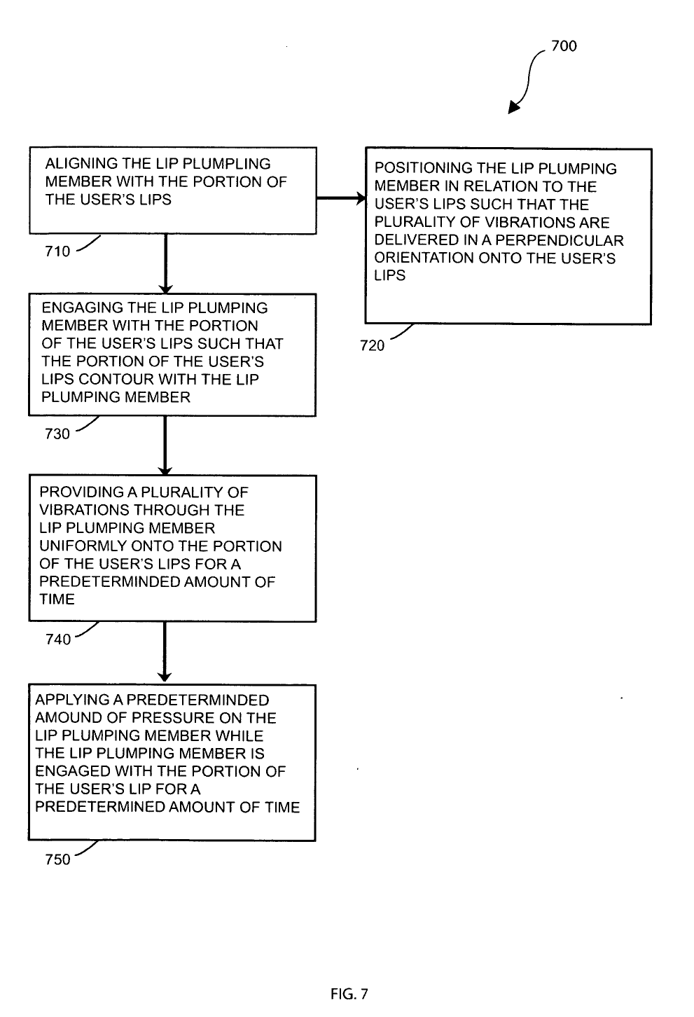

Now that the structural features of the lip augmentation device have been disclosed, the present invention as illustrated in FIG. 7 includes a method of uniformly augmenting at least a portion of a user's lips with a lip augmentation device 700. In the method 700, the lip augmentation device includes a housing, a lip plumping member, and a vibrating member.

Referring again to FIG. 7, the method 700 includes aligning the lip plumping member with the portion of the user's lips 710. In method 710, and as shown in FIGS. 6a and 6b, the user ensures that the lip plumping member is aligned with at least a portion of the user's lips so as to allow the lip plumping member to accommodate the portion of the user's lips. While aligning the lip plumping member to accommodate the portion of the lips 710, the method 700 further includes positioning the lip plumping member in relation to the portion of the user's lips such that the plurality of vibrations are delivered in a perpendicular orientation onto the portion of the user's lips 720. In method 720, the user positions the lip augmentation device so as to allow the plurality of vibrations from the lip plumping member to vibrate the user's lips in a perpendicular or an “up and down” motion.

Furthermore, as shown in FIG. 7, the method 700 includes engaging the lip plumping member with the portion of the user's lips such that the portion of the user's lips contour with the lip plumping member 730. In method 730, the lip plumping member is structured to sufficiently accommodate the portion of the user's lips desired for augmentation as shown in FIG. 5 and FIG. 6. Once contact is established between the user's lips and the lip plumping member, the user's lips contour with the lip plumping member by allowing the surface of the user's lips to sufficiently engage with the lip plumping member.

Referring to FIG. 7 yet again, the method 700 includes providing a plurality of vibrations through the lip plumping member uniformly onto the portion of the user's lips for a predetermined amount of time 740. In method 740, the uniformly dispersed vibrations on the lip plumping member allows for uniform augmentation of at least a portion of the user's lips. Specifically, the plurality of vibrations provided through the lip plumping member has a frequency in the range of about 40 Hertz to about 100 Hertz. Accordingly, the user may augment the lips for a predetermined amount of time and/or until desired results for augmentation are obtained.

As shown in FIG. 7, the method 700 further includes applying a predetermined amount of pressure onto the lip plumping member, while the lip plumping member is engaged with the portion of the user's lips for a predetermined amount of time 750. In method 750, the user applies pressure onto the lip plumping member for a predetermined amount of time to allow the plurality of vibrations from the lip plumping member to effectively vibrate the engaged portion of the user's lips within the desired range of frequency and amplitude.

Any of the above methods may be completed in sequential order in at least one preferred embodiment, though they may be completed in any other order in other preferred embodiments. In at least one of the preferred embodiments, the above methods may be exclusively performed, but in other preferred embodiments, one or more steps of the methods as described may be skipped.

Since many modifications, variations and changes in detail can be made to the described preferred embodiment of the invention, it is intended that all matters in the foregoing description and shown in the accompanying drawings be interpreted as illustrative and not in a limiting sense. It is to be understood that the present disclosure has been made by way of example only and that numerous changes in the detailed construction and the combination and arrangement of parts may be resorted to without departing from the spirit and scope of the invention as hereinafter claimed. Thus, the scope of the invention should be determined by the appended claims and their legal equivalents.

What is claimed is:

1. A lip augmentation device comprising:
a housing,
a vibrating member disposed within said housing,
a lip plumping member operably attached to said housing and disposed in a vibrating relation with said vibrating member, and
said lip plumping member disposed to uniformly augment at least a portion of a user's lips.

2. The lip augmentation device as recited in claim 1 wherein said lip plumping member is structured and disposed to receive at least a portion of the user's lips such that said lip plumping member is contacting with the portion of the lips.

3. The lip augmentation device as recited in claim 2 wherein said lip plumping member is substantially concave in relation to the user's lips allowing the portion of the user's lips to contour with said lip plumping member.

4. The lip augmentation device as recited in claim 1 wherein said lip plumping member comprises a plurality of groove and ridge members, wherein each of said plurality of groove and ridge members is positioned in a substantially adjacent and parallel relation to each other.

5. The lip augmentation device as recited in claim 4 wherein each of said plurality of groove and ridge members is disposed to receive a plurality of vibrations from said vibrating member.

6. The lip augmentation device as recited in claim 5 wherein the plurality of vibrations provided by said vibrating member have a frequency in the range of about 40 Hertz to about 100 Hertz.

7. The lip augmentation device as recited in claim 5 wherein the plurality of vibrations provided by said vibrating member is uniformly dispersed throughout said lip plumping member.

8. The lip augmentation device as recited in claim 5 wherein the plurality of vibrations provided by said vibrating member is uniformly dispersed throughout each of said plurality of groove and ridge members.

9. The lip augmentation device as recited in claim 1 further comprising a bushing member positioned within said housing and disposed to allow the plurality of vibrations to be dampened.

10. A lip augmentation device including a plurality of vibrations to uniformly augment at least a portion of a user's lips comprising:
a housing,
a vibrating member disposed in said housing,
a lip plumping member operably attached to said housing and disposed in a vibrating relation to said vibrating member,
said lip plumping member further comprising a plurality of groove and ridge members, and
said lip plumping member disposed to uniformly augment the portion of the user's lips.

11. The lip augmentation device as recited in claim 10 wherein said lip plumping member is structured to be substantially convex in relation to the portion of the user's lips, sufficient for the portion of the user's lips to contour with said lip plumping member.

12. The lip augmentation device as recited in claim 10 wherein said vibrating member is disposed to provide the plurality of vibrations, wherein the plurality of vibrations are uniformly dispersed throughout said lip plumping member.

13. The lip augmentation device as recited in claim 12 wherein said lip plumping member is disposed to provide the plurality of vibrations uniformly onto the portion of the user's lips.

14. The lip augmentation device as recited in claim 12 wherein said lip plumping member is disposed to provide the plurality of vibrations in a perpendicular orientation in relation to the user's lips.

15. The lip augmentation device as recited in claim 12 wherein said lip plumping member is disposed to provide the plurality of vibrations onto each of said plurality of groove and ridge members, wherein the plurality of vibrations are uniformly distributed onto each of said plurality of groove and ridge members.

16. The lip augmentation device as recited in claim 10 further comprising a button switch member disposed on said housing.

17. A method of uniformly augmenting at least a portion of a user's lips with a lip augmentation device comprising a housing, a lip plumping member, and a vibrating member, the method comprising:
aligning the lip plumping member with the portion of the user's lips,
engaging the lip plumping member with the portion of the user's lips such that the portion of the user's lips contour with the lip plumping member, and
providing a plurality of vibrations through the lip plumping member uniformly onto the portion of the user's lips for a predetermined amount of time.

18. The method as recited in claim 17 further comprising:
applying a predetermined amount of pressure on the lip plumping member while the lip plumping member is engaged with the portion of the user's lips for a predetermined amount of time.

19. The method as recited in claim 17 further comprising:
positioning the lip plumping member in relation to the portion of the user's lips such that the plurality of vibrations are delivered in a perpendicular orientation onto the portion of the user's lips.

20. The method as recited in claim 17 wherein the plurality of vibrations provided through the lip plumping member have a frequency in the range of about 40 Hertz to about 100 Hertz.
